(19) United States
(12) Patent Application Publication
(10) Pub. No.: US 2026/0080527 A1
(43) Pub. Date: Mar. 19, 2026

(54) ANALYSIS METHOD, ANALYSIS DEVICE, ANALYSIS SYSTEM, STORAGE MEDIUM, AND HEAD MOUNTED DISPLAY

(71) Applicant: Kabushiki Kaisha Toshiba, Kawasaki-shi (JP)

(72) Inventors: Yasutomo Shiomi, Koza Kanagawa (JP); Lisa Masuda, Yokohama Kanagawa (JP); Mitsuo Sasaki, Chigasaki Kanagawa (JP)

(21) Appl. No.: 19/329,304

(22) Filed: Sep. 15, 2025

(30) Foreign Application Priority Data
Sep. 19, 2024 (JP) 2024-162185

(51) Int. Cl. G06T 7/00; B23K 3/08; G02B 27/01

(52) U.S. Cl. CPC G06T 7/0004; B23K 3/08; G02B 27/0172; G02B 2027/0138; G02B 2027/014; G06T 2207/10016; G06T 2207/10024; G06T 2207/20192; G06T 2207/20216; G06T 2207/30136

(57) ABSTRACT

According to one embodiment, an analysis method analyzes a brazing task of first and second members. In the method, a computer acquires a first image of a first wavelength band and a second image of a second wavelength band, the second wavelength band having a longer wavelength than the first wavelength band. The computer determines a first period based on pixel values including a pixel value of the first image and a pixel value of one or more of the first images acquired previously, a disturbance to the analysis occurring in the first period. The computer determines whether a timing at which the second image is imaged is included in the first period. When the timing is not included in the first period, the computer uses the second image to determine whether heating states of the first and second members are sufficient.

### CROSS-REFERENCE TO RELATED APPLICATIONS

This application is based upon and claims the benefit of priority from Japanese Patent Application No.2024-162185, filed on Sep. 19, 2024; the entire contents of which are incorporated herein by reference.

### FIELD

Embodiments of the invention generally relate to an analysis method, an analysis device, an analysis system, a program, a storage medium, and a head mounted display.

### BACKGROUND

A brazing task may be performed when manufacturing an article. To improve the quality of brazed products, analysis of the brazing task based on images is being attempted. There is a need for technology that can increase the analysis accuracy of the brazing task by using images.

### BRIEF DESCRIPTION OF THE DRAWINGS

FIG. 1 is a schematic view showing a configuration of an analysis system according to an embodiment;

FIG. 2 is a flowchart showing an analysis method according to the embodiment;

FIG. 3 is an image of a brazing task;

FIG. 4A is an example of a first image of a first wavelength band, and FIG. 4B is an example of a second image of a second wavelength band;

FIG. 5 is a graph showing an example of a first waveform; FIG. 6 is a graph showing another example of the first waveform;

FIGS. 7A and 7B are images of the brazing task;

FIG. 8 is a flowchart showing a specific example of a first determination;

FIGS. 9A to 9C are images of a specific example of the first determination;

FIG. 10 is a graph showing pixel values along line X-X of FIG. 9C;

FIG. 11 is a flowchart showing a specific example of a second determination;

FIG. 12 is a graph showing the pixel values along line X-X of FIG. 9C;

FIG. 13 is a graph showing pixel values of another image;

FIG. 14 is a graph showing an example of a relationship between the wavelength and the pixel value;

FIG. 15 is a graph showing an example of a change of the pixel value with respect to the wavelength;

FIG. 16 is a schematic view showing a configuration of an imaging device;

FIG. 17 is a schematic view illustrating a configuration of a computer that performs the analysis method according to the embodiment;

FIG. 18 is a perspective view showing an example of a head mounted display;

FIG. 19 is a schematic view showing a display example of the head mounted display;

FIG. 20 is a schematic view showing a display example of the head mounted display; and

FIG. 21 is a schematic view showing a display example of the head mounted display.

### DETAILED DESCRIPTION

According to one embodiment, an analysis method analyzes a brazing task of first and second members. In the method, a computer acquires a first image of a first wavelength band in which the brazing task is visible. The computer acquires a second image of a second wavelength band in which the brazing task is visible, the second wavelength band having a longer wavelength than the first wavelength band. The computer determines a first period based on a plurality of pixel values including a pixel value of the first image and a pixel value of one or more of the first images acquired previously, a disturbance to the analysis occurring in the first period. The computer determines whether or not a timing at which the second image is imaged is included in the first period. When the timing is not included in the first period, the computer performs a first determination of using the second image to determine whether or not a heating state of the first member is sufficient and whether or not a heating state of the second member is sufficient.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

An embodiment of the invention is applied to a brazing task. In the brazing task, two members are joined by a brazing material. First, the two members are caused to approach each other; and the joining locations of the members are sufficiently heated by a flame. When the joining locations are sufficiently heated, the brazing material is brought into contact with the joining locations. The brazing material melts and adheres to the joining locations. When a sufficient amount of the brazing material has adhered to the joining locations, the heating is stopped, and the members are cooled. The brazing material is solidified by the cooling, and the two members are joined.

The members (the base materials) to be joined are made of metal or made of ceramic. For example, when the base materials are made of metal, the base materials include copper or steel. When the base materials are made of ceramic, the base materials include aluminum nitride, aluminum oxide, zirconia, etc. When joining such base materials, a metal such as phosphorus copper, aluminum, etc., that has a lower melting point than the base materials is used as the brazing material.

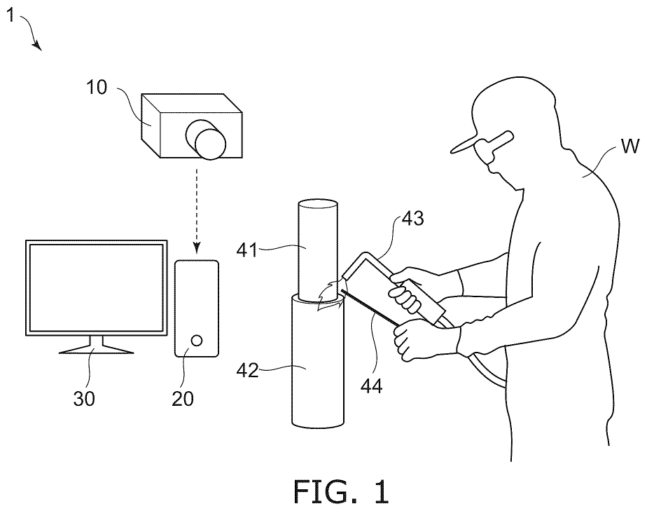

FIG. 1 is a schematic view showing a configuration of an analysis system according to an embodiment.

As shown in FIG. 1, the analysis system 1 according to the embodiment includes an imaging device 10, a computer 20, and a display device 30.

In the example shown in FIG. 1, a worker W brazes a first member 41 and a second member 42. The worker W holds a burner 43 in the right hand and holds a wire-shaped brazing material 44 in the left hand.

The imaging device 10 acquires an image by imaging the joining locations of the first and second members 41 and 42. At this time, the imaging device 10 acquires images of two mutually-different wavelength bands (a first wavelength band and a second wavelength band). The wavelengths of the second wavelength band are greater than the wavelengths of the first wavelength band. The first wavelength band and the second wavelength band do not overlap. The imaging device 10 acquires the first image of the first wavelength band and the second image of the second wavelength band that are imaged at the same timing. The imaging area of the first image and the imaging area of the second image are the same. The imaging device 10 repeatedly acquires the first and second images during the brazing task.

The computer 20 includes a processing circuit that performs various processing, memory that stores programs, etc. The computer 20 can be a general-purpose personal computer (PC). The processing circuit acquires the first and second images acquired by the imaging device 10. The computer 20 may directly receive images from the imaging device 10. The imaging device 10 may store the images in a memory region such as a storage device, a network server, etc. ; and the computer 20 may acquire the images from the memory region.

The computer 20 functions as an analysis device that performs analysis related to the brazing task. The computer 20 analyzes the brazing task by using the acquired images. The display device 30 displays the analysis results of the computer 20 to the worker W.

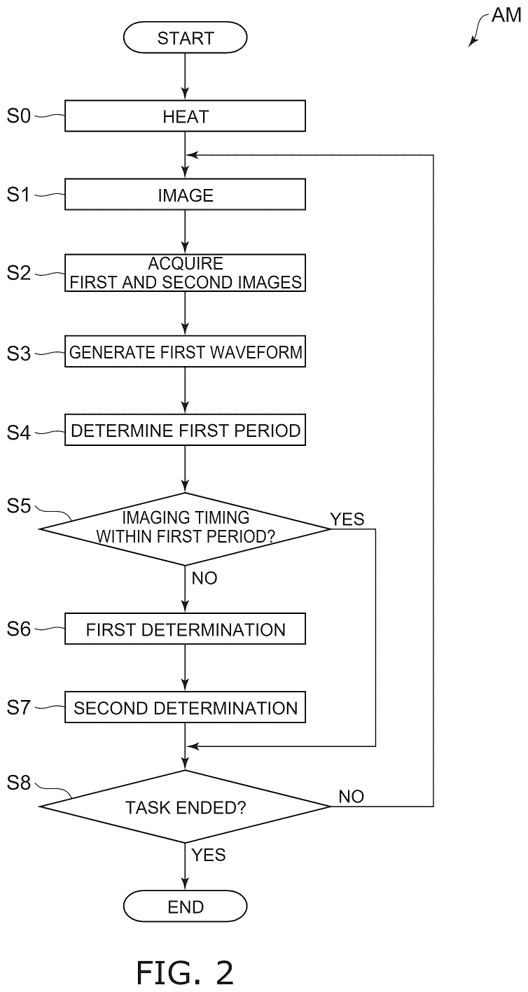

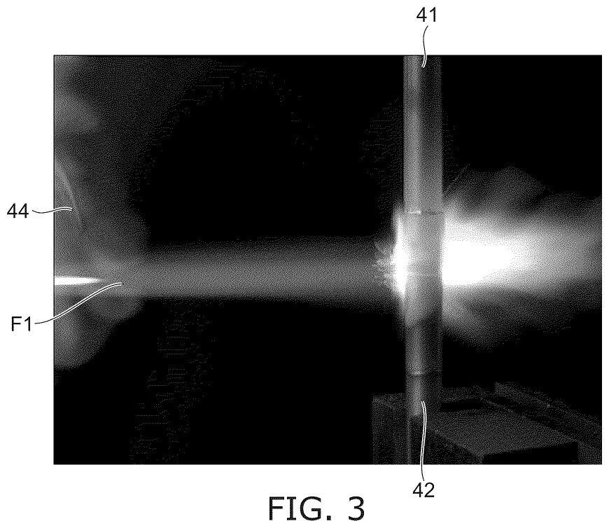

FIG. 2 is a flowchart showing an analysis method according to an embodiment. FIG. 3 is an image of the brazing task.

In the analysis method AM shown in FIG. 2, first, the worker W uses the burner 43 to heat the first member 41 and the second member 42 (step S0). FIG. 3 illustrates the appearance viewed by the worker W. In the example of FIG. 3, the first member 41 and the second member 42 are heated by a flame F1 of the burner 43. For example, the first member 41 and the second member 42 are made of copper and are brown in the unheated state. The temperature of the flame F1 vicinity to the burner 43 is about 1,400 to 1,800° C.; and the flame F1 is blue.

The imaging device 10 images the brazing task and stores the first image of the first wavelength band and the second image of the second wavelength band (step S1). The computer 20 acquires the first and second images (step S2).

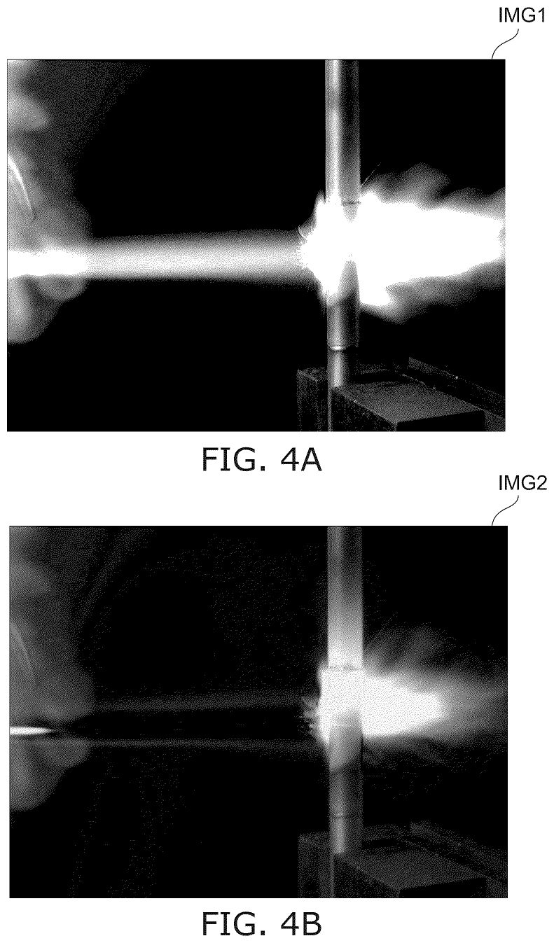

FIG. 4A is an example of the first image of the first wavelength band. FIG. 4B is an example of the second image of the second wavelength band.

FIGS. 4A and 4B are the first and second images that are imaged at the timing of FIG. 3. In the example, the first wavelength band is 530±40 nm. The first image IMG1 shown in FIG. 4A is an optical image based on light of wavelengths within the range of 530±40 nm. The second wavelength band is 630±60 nm. The second image IMG2 shown in FIG. 4B is an optical image based on light of wavelengths within the range of 630±60 nm.

The computer 20 acquires a pixel value from the first image. The computer 20 also refers to pixel values of multiple first images acquired previously. The computer 20 generates a first waveform by using the pixel value of the latest first image and pixel values of multiple previous first images (step S3).

FIG. 5 is a graph showing an example of the first waveform. FIG. 6 is a graph showing another example of the first waveform.

For example, the computer 20 generates the first waveform shown in FIG. 5. In FIG. 5, the horizontal axis is a time T, and the vertical axis is a pixel value (a luminance) V. The imaging device 10 repeats the imaging during the brazing task. Multiple first images and multiple second images are obtained by repeating the imaging. As a result, the first waveform is generated using a pixel value of the acquired first image.

Based on the first waveform, the computer 20 determines the first period in which a disturbance of the analysis occurred (step S4). For example, as shown in FIG. 5, the computer 20 compares the pixel value V to a preset threshold th1. A period in which the pixel value V is not less than the threshold th1 is determined as the first period P1. When multiple periods in which the pixel values V are not less than the threshold th1 are present and the spacing between the periods is less than a prescribed period of time, the computer 20 may collectively determine the multiple periods and the periods between the multiple periods as the first period P1.

As shown in FIG. 6, the computer 20 may differentiate the pixel value V with respect to the time T and generate the first waveform of the change dV/dT of the pixel value with respect to the time T. The computer 20 compares the absolute value of the change dV/dT to a preset threshold th2. The period in which the change dV/dT is not less than the threshold th2 is determined as the first period P1. When multiple periods in which the change dV/dT is not less than the threshold th2 are present and the spacing between the periods is less than a prescribed period of time, the computer 20 may collectively determine the multiple periods and the periods between the multiple periods as the first period P1.

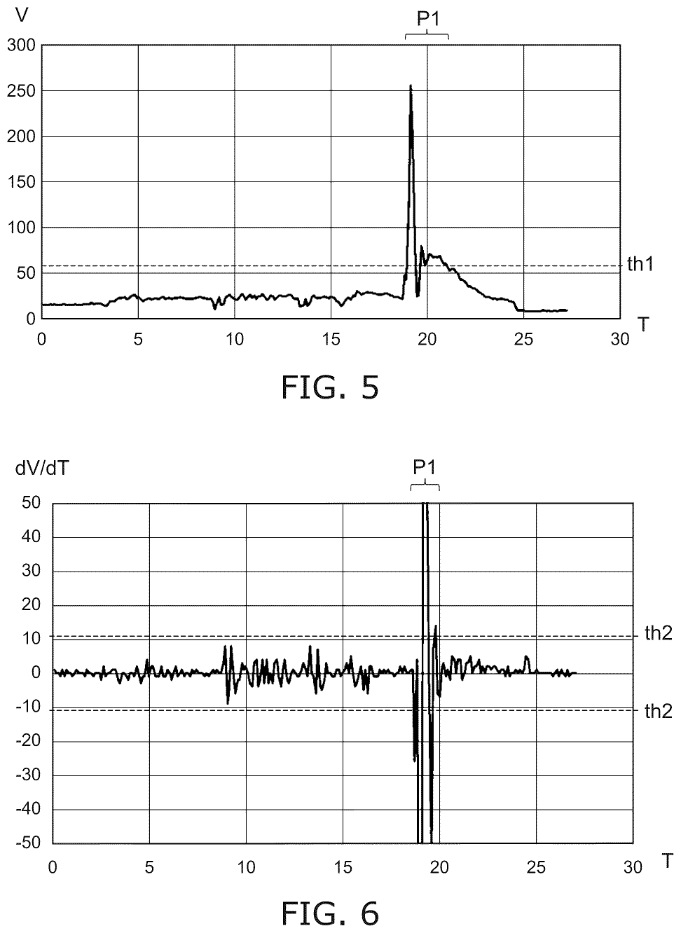

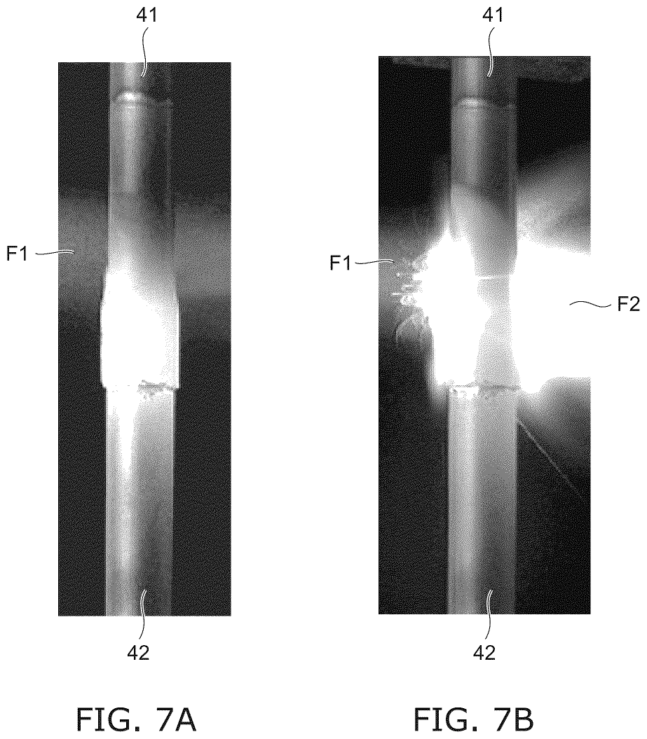

FIGS. 7A and 7B are images of the brazing task.

The disturbances to the analysis of the brazing task include the occurrence of a flame from the heated base material, the occurrence of a flame from scattered base material components, etc. FIG. 7A is an image when there is no flame from the base material. The first member 41 and the second member 42 are heated by the flame F1 from the burner 43; and the first member 41 and the second member 42 are red hot and bright. In FIG. 7B, a flame F2 has formed from the first and second members 41 and 42. The flame F2 is brighter than the flame F1, the first member 41, the second member 42, etc. Therefore, the flame F2 may be a disturbance that obstructs the analysis.

The computer 20 determines whether or not the timing at which the second image was imaged is included in the first period P1 (step S5). The computer 20 performs the first determination when the imaging timing is not included in the first period P1 (step S6). The first determination uses the second image to determine whether or not the heating state of the first member 41 is sufficient and to determine whether or not the heating state of the second member 42 is sufficient.

The color of a metal member changes when the temperature is increased by heating. For example, when the first member 41 and the second member 42 are made of copper, the first member 41 and the second member 42 change to red when heated to about 700 to 800° C. The brightness of red is dependent on the temperature. In other words, the pixel values of the first member 41 and the pixel values of the second member 42 visible in the second image increase as the temperatures of the first and second members 41 and 42 increase. The computer 20 can perform the first determination by using a pixel value of the first member 41 and a pixel value of the second member 42 of the second image.

For example, the imaging device 10 is disposed so that only the joining locations are visible in the second image. In such a case, the computer 20 calculates the average of all of the pixel values of the second image. When the average value is not less than a preset threshold, the computer 20 determines the heating state of the first member 41 to be sufficient and determines the heating state of the second member 42 to be sufficient.

One imaging device 10 that images only the joining location of the first member 41 and another imaging device 10 that images only the joining location of the second member 42 may be included. In such a case, the computer 20 calculates the average of all of the pixel values of the second image that is imaged by the one imaging device 10 as the pixel value of the first member 41. The computer 20 calculates the average of all of the pixel values of the second image that is imaged by the other imaging device 10 as the pixel value of the second member 42. When the pixel value of the first member 41 is not less than a preset threshold, the computer 20 determines that the first member 41 is sufficiently heated. When the pixel value of the second member 42 is not less than the preset threshold, the computer 20 determines that the second member 42 is sufficiently heated.

When objects or spaces other than the first and second members 41 and 42 are visible in one second image, the computer 20 may extract the first member 41 and the second member 42 from the second image. For example, the region of the first member 41 and the region of the second member 42 are preset in the second image. The computer 20 cuts out the region set as the first member 41 and the region set as the second member 42 from the second image.

Or, the computer 20 may extract an edge of the first member 41 and an edge of the second member 42 from the second image. The computer 20 determines a region surrounded with edges of the first member 41 to be the first member 41. The computer 20 determines a region surrounded with edges of the second member 42 to be the second member 42. The computer 20 calculates the average of at least a portion of the pixel values of the region of the first member 41. When the average value is not less than a preset threshold, the computer 20 determines the first member 41 to be sufficiently heated. The computer 20 calculates the average of at least a portion of the pixel values of the region of the second member 42. When the average value is not less than the preset threshold, the computer 20 determines the second member 42 to be sufficiently heated.

Edge detection of image processing can be used to extract the edges. Or, an image processing model for extracting the edges may be prepared. The image processing model is machine-learned beforehand to output the edges of the first member 41 and the edges of the second member 42 according to the input of an image including the first and second members 41 and 42. It is favorable for the image processing model to include a convolutional neural network.

The computer 20 also may perform a second determination (step S7). The second determination determines the uniformity between the heating state of the first member 41 and the heating state of the second member 42. As described above, the pixel value of the first member 41 and the pixel value of the second member 42 are dependent respectively on the temperature of the first member 41 and the temperature of the second member 42. Accordingly, a large difference between the pixel value of the first member 41 and the pixel value of the second member 42 in the second image indicates that the first member 41 and the second member 42 are not uniformly heated. The computer 20 determines the first member 41 and the second member 42 to be uniformly heated when the difference between the pixel value of the first member 41 and the pixel value of the second member 42 in the second image is less than a preset threshold.

For example, as described above, a second image in which only the joining location of the first member 41 is visible and a second image in which only the joining location of the second member 42 is visible are acquired. Or, the region of the first member 41 and the region of the second member 42 in the second image are preset. The edges of the first member 41 and the edges of the second member 42 may be extracted from the second image. The difference between the pixel value of the first member 41 and the pixel value of the second member 42 is calculated by using either method to acquire the pixel value of the first member 41 and the pixel value of the second member 42.

When the imaging timing is determined to be included in the first period P1 in step S5, the computer 20 does not perform the first and second determinations. Or, the computer 20 may perform the first and second determinations but treat the results of the determinations as invalid.

Subsequently, the computer 20 determines whether or not the brazing task has ended (step S8). The method returns to step S1 when the brazing task has not ended. As a result, the brazing task while heating is imaged again.

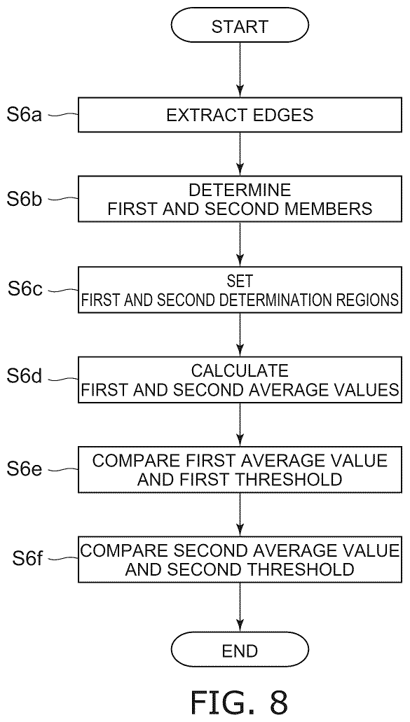

FIG. 8 is a flowchart showing a specific example of the first determination.

An example of specific processing of the first determination will now be described with reference to FIG. 8. First, the computer 20 extracts the edges of the first member 41 and the edges of the second member 42 from an image (step S6a). Either the first image or the second image may be used to extract the edges. Based on the edge extraction result, the computer 20 determines the first member 41 and the second member 42 in the image (step S6b). For example, a function such as findContours or the like is used to extract regions surrounded with the edges. Based on the positional relationship and the relationship between the areas of the multiple regions that are extracted, one of the multiple regions is determined to be the first member 41; and another of the multiple regions is determined to be the second member 42. In the example shown in FIGS. 7A and 7B, the largest region at the upper side of the image is determined to be the first member 41; and the largest region at the lower side of the image is determined to be the second member 42.

The computer 20 sets a first determination region to be the region of the image determined to be the first member 41. The computer 20 sets a second determination region to be the region of the image determined to be the second member 42 (step S6c). The first determination region and the second determination region are the regions that are used for the first determination. For example, the center vicinity of the joining location of the first member 41 is set as the first determination region. The center vicinity of the joining location of the second member 42 is set as the second determination region.

The computer 20 acquires a first average value by calculating the average of the pixel values in the first determination region. The computer 20 acquires a second average value by calculating the average of the pixel values in the second determination region (step S6d). The average may be a simple average or a weighted average.

The computer 20 compares the first average value to a preset first threshold (step S6e). When the first average value is not less than the first threshold, the computer 20 determines the heating state of the first member 41 to be sufficient. When the first average value is less than the first threshold, the computer 20 determines the heating state of the first member 41 to be insufficient.

The computer 20 compares the second average value to a preset second threshold (step S6f). The second threshold may be equal to the first threshold or different from the first threshold. When the second average value is not less than the second threshold, the computer 20 determines the heating state of the second member 42 to be sufficient. When the second average value is less than the second threshold, the computer 20 determines the heating state of the second member 42 to be insufficient.

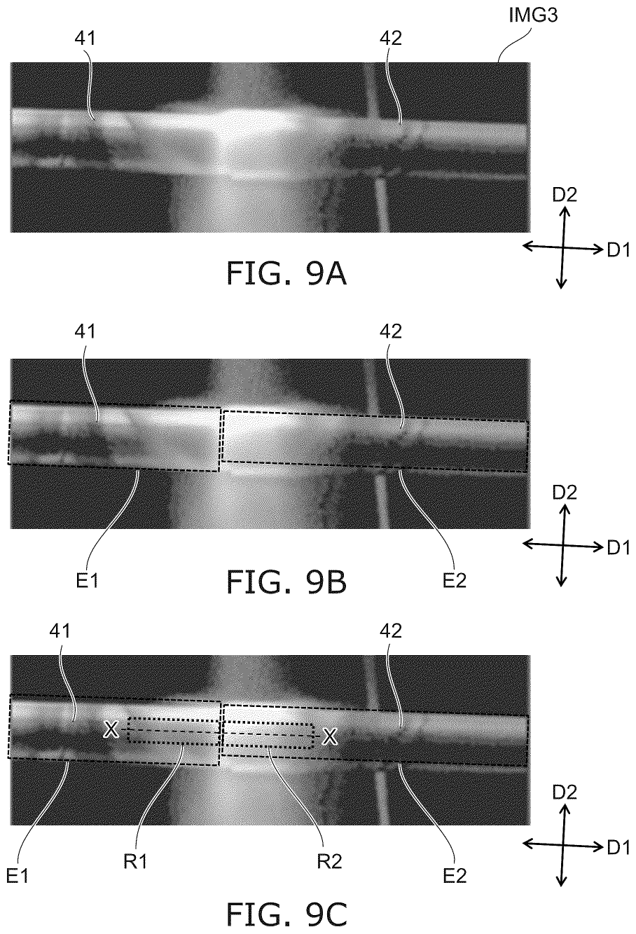

FIGS. 9A to 9C are images of a specific example of the first determination.

For example, the imaging device 10 acquires an image IMG3 shown in FIG. 9A. As shown in FIG. 9B, the computer 20 extracts edges E1 of the first member 41 and edges E2 of the second member 42 from the image IMG3. The computer 20 determines the region surrounded with the edges E1 to be the first member 41. The computer 20 determines the region surrounded with the edges E2 to be the second member 42.

As shown in FIG. 9C, the computer 20 sets a first determination region R1 to be the first member 41. In the illustrated example, the first member 41 and the second member 42 are pipes extending in a first direction D1. The first determination region R1 is positioned on the first member 41 at the second member 42 side. The first determination region R1 is separated from the edges E1 in a second direction D2 perpendicular to the first direction D1 and is positioned at the central portion of the first member 41. For example, the computer 20 uniformly trisects the first member 41 in the second direction D2. The computer 20 sets the first determination region R1 to be the region at the center of the uniformly trisected regions.

The computer 20 sets a second determination region R2 in the second member 42. The second determination region R2 is positioned on the second member 42 at the first member 41 side. The second determination region R2 is separated from the edges E2 in the second direction D2, and is positioned at the central portion of the second member 42. For example, the second determination region R2 is set to be the region at the center among regions of the second member 42 uniformly trisected in the second direction D2.

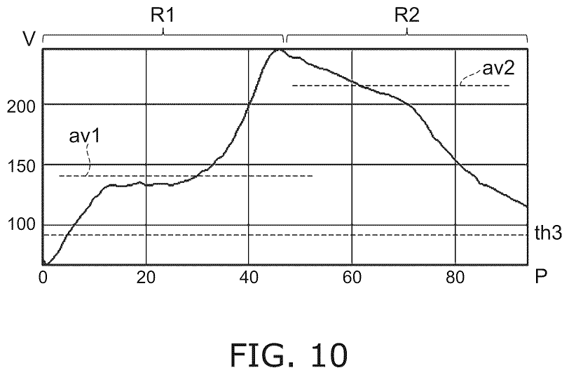

FIG. 10 is a graph showing pixel values along line X-X of FIG. 9C.

In FIG. 10, the horizontal axis is a position P in the first direction D1. The vertical axis is the pixel value (the luminance) V. The computer 20 calculates a first average value av1 of the region determined to be the first member 41. A second average value av2 of the region determined to be the second member 42 is calculated.

The computer 20 compares the first average value av1 and the second average value av2 to a threshold th3. The threshold th3 is an example of the first and second thresholds. In the example, the first threshold and the second threshold are the same. The first average value av1 and the second average value av2 are greater than the threshold th3. Therefore, the computer 20 determines the heating state of the first member 41 to be sufficient, and determines the heating state of the second member 42 to be sufficient.

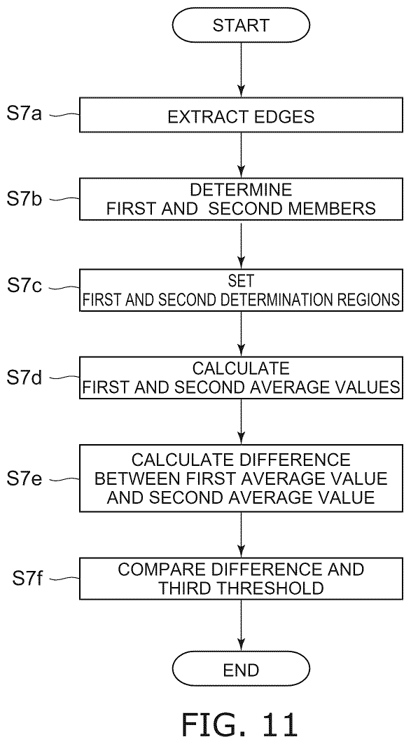

FIG. 11 is a flowchart showing a specific example of the second determination.

An example of specific processing of the second determination will now be described with reference to FIG. 11. First, the computer 20 extracts the edges of the first member 41 and the edges of the second member 42 from an image (step S7a). The computer 20 determines the first member 41 and the second member 42 based on the edge extraction result (step S7b). The computer 20 sets the first and second determination regions (step S7c). The computer 20 calculates the first and second average values (step S7d). Steps S7a to S7d can be performed by a method similar to steps S6a to S6d. Steps S7a to S7d may be omitted by using the results of steps S6a to S6d in the second determination.

The computer 20 calculates the difference between the first average value and the second average value (step S7e). The computer 20 compares the difference to a preset third threshold (step S7f). When the difference is not less than the third threshold, the computer 20 determines that the heating state of the first member 41 and the heating state of the second member 42 are nonuniform. When the difference is less than the third threshold, the computer 20 determines that the heating state of the first member 41 and the heating state of the second member 42 are uniform.

A ratio of the first average value and the second average value may be used instead of the difference. For example, when the ratio of the second average value to the first average value is within a preset range, the computer 20 determines that the heating state of the first member 41 and the heating state of the second member 42 are uniform.

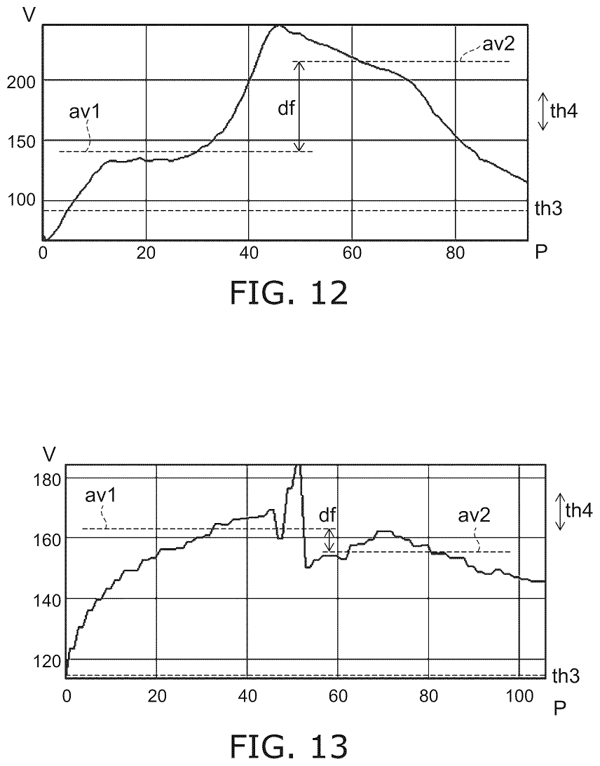

FIG. 12 is a graph showing the pixel values along line X-X of FIG. 9C.

The graph of FIG. 12 is the same as the graph of FIG. 10. As shown in FIG. 12, the computer 20 calculates a difference df between the first average value av1 and the second average value av2. The computer 20 compares the difference df to a preset threshold th4 (an example of the third threshold). In the illustrated example, the difference df is greater than the threshold th4. Therefore, the computer 20 determines that the heating state of the first member 41 and the heating state of the second member 42 are nonuniform.

FIG. 13 is a graph showing pixel values of another image. In the example shown in FIG. 13, both the first and second average values av1 and av2 are greater than the threshold th3. Therefore, the computer 20 determines the heating state of the first member 41 to be sufficient and determines the heating state of the second member 42 to be sufficient. The difference df between the first average value av1 and the second average value av2 is less than the threshold th4. Therefore, the computer 20 determines that the heating state of the first member 41 and the heating state of the second member 42 are uniform.

Advantages of the embodiment will now be described.

A worker may perform a brazing task when manufacturing an article. When brazing is performed by a worker, the quality of the brazing is dependent on the experience and skill of the worker. For example, it is desirable to supply the brazing material after the base material is sufficiently heated. If the brazing material is supplied in a state in which the heating of the base material is insufficient, the brazing material will not melt, and normal brazing is not possible. Also, it is necessary to continue heating the brazing material until the brazing material melts on the base material. In such a case, there is a possibility that the base material around the brazing material may be unnecessarily heated, and the base material may degrade.

Methods to support appropriate brazing tasks include mounting multiple sensors to the worker, the burner, the surroundings of the worker and the burner, etc. In such a method, the brazing task is analyzed based on the detection results of the sensors. However, in such a case, it takes time and effort to mount the sensors, and there is also a possibility that the sensors may obstruct the task.

There is also an analysis method that omits sensors by using a camera. The appropriate brazing task is supported by imaging the brazing task with a camera and by analyzing the image. According to such a method, the brazing task can be easily analyzed because the time and effort of mounting multiple sensors is unnecessary.

On the other hand, disturbances to the analysis are a problem when a camera is used. The disturbances occur due to combustion of the surface of the heated base material or components scattering from the base material, which results in a flame reaction. A flame of which the color has changed due to a flame reaction is extremely bright compared to a burner flame, the heated base material, etc. Therefore, the image greatly changes when a flame reaction occurs. The occurrence of a disturbance makes it difficult to analyze by using a camera. Hereinafter, a flame that occurs due to a flame reaction of the base material also is referred to as “a flame from the base material”.

In the analysis method according to the embodiment, two types of images of the first image of the first wavelength band and the second image of the second wavelength band are used to analyze the brazing task. The first image and the second image are optical images based on light of mutually-different wavelength bands. The first wavelength band is set to match the color of the flame from the base material. The first image is acquired to check for the occurrence of a disturbance to the analysis. The second wavelength band is set to match the color of the heated base material. The second image is acquired to analyze the brazing task.

When the first image and the second image are acquired, the first period in which the disturbance to the analysis occurs is determined based on a pixel value of the latest first image and pixel values of multiple first images acquired previously. For example, as shown in FIG. 5, the first period includes a period in which the pixel value is greater than a preset threshold. Or, as shown in FIG. 6, the first period includes a period in which the change of the pixel value with respect to time is greater than a preset threshold.

When the first period in which the disturbance occurred has been determined, it is determined whether or not the timing at which the second image was imaged is included in the first period. When the imaging timing is not included in the first period, the first determination is performed. In the first determination, the second image is used to determine whether or not the heating state of the first member is sufficient and whether or not the heating state of the second member is sufficient.

According to the embodiment, the brazing task is analyzed using the second image that is imaged at a timing at which no disturbance is occurring. Therefore, the accuracy of the determination of the heating state of the first member and the heating state of the second member can be increased.

In the analysis method according to the embodiment, the second determination may be performed in addition to the first determination. Even when the first member and the second member each are sufficiently heated, if the difference between the temperature of the first member and the temperature of the second member is large, the brazing material may not be appropriately supplied to the joining location between the first member and the second member; and the joining strength may be reduced. Also, the melting of the brazing material may be different between the first member and the second member; the first member and the second member may not be joined uniformly; and the joining strength may be reduced. In the second determination, the uniformity between the heating state of the first member and the heating state of the second member is determined. In the second determination, the joining strength can be increased by supplying the brazing material to the joining location when it is determined that the heating state of the first member and the heating state of the second member are uniform.

Generally, the flame of a gas burner is blue. The flame from a base material when the base material is heated by a burner is blue to yellow. Therefore, the first wavelength band can be selected from the range of not less than 420 nm but less than 620 nm. By selecting the first wavelength band from the range of not less than 420 nm but less than 620 nm, the first period in which the disturbance occurs can be determined with higher accuracy.

The base material is made of metal. Generally, metals appear orange to red when heated to about the melting point of a brazing material. Therefore, the second wavelength band can be selected from the range of not less than 650 nm but less than 950 nm. By selecting the second wavelength band from the range of not less than 650 nm but less than 950 nm, flames are not easily visible in the image; and the accuracy of the first determination can be increased.

To increase the accuracy of the analysis, it is favorable for the range of the first wavelength band and the range of the second wavelength band to be narrow. For example, the first wavelength band is set to be narrow to correspond to the color of the flame from the base material. As a result, the first period can be determined with higher accuracy based on only the flame from the base material. The second wavelength band is set to be narrow to correspond to the color of the base material that is heated near the melting point of the brazing material. As a result, the accuracy of the first determination can be increased based on only the temperature of the heated base material.

For example, the difference between the upper limit and lower limit of the first wavelength band is less than 20 nm; and the difference between the upper limit and lower limit of the second wavelength band is less than 20 nm. It is favorable for these differences to be less than 15 nm, and more favorably less than 10 nm.

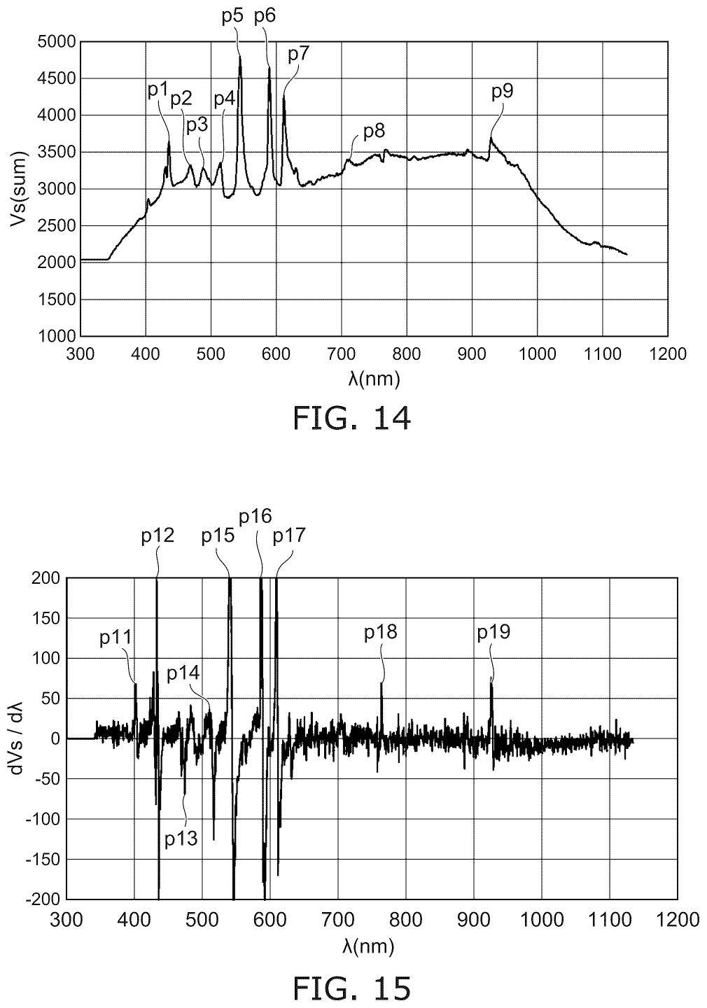

FIG. 14 is a graph showing an example of a relationship between the wavelength and the pixel value. FIG. 15 is a graph showing an example of the change of the pixel value with respect to the wavelength.

An example of the method for selecting the first and second wavelength bands will now be described with reference to FIGS. 14 and 15. First, the first member 41 and the second member 42 are heated while imaging the first member 41 and the second member 42. The relationship (spectral data) between the wavelength and the pixel value is acquired by imaging. The spectral data can be acquired by a spectral camera (a hyperspectral camera, a multispectral camera, etc.).

The spectral data is acquired when a flame from the base material occurs. FIG. 14 is an example of the spectral data when the flame from the base material occurred. In FIG. 14, the horizontal axis is a wavelength λ. The vertical axis is a total Vs of the pixel values of the light at wavelengths included in the image. Peaks p1 to p9 occur in FIG. 14. For example, the wavelength band at which one of the peaks p1 to p9 occurred can be used as the first wavelength band.

Or, the spectral data may be differentiated with respect to the wavelength. FIG. 15 shows the results of the pixel value of the spectral data of FIG. 14 differentiated with respect to the wavelength. Peaks p11 to p19 of dVs/dλ occur in FIG. 15. For example, the wavelength band in which one of the peaks p11 to p19 occurred can be used as the first wavelength band.

The second wavelength band is selected from the range of colors of the base material when heated. At this time, the second wavelength band is selected to avoid the wavelength bands at which the peaks p1 to p9 and the peaks p11 to p19 occurred because the peaks p1 to p9 and the peaks p11 to p19 are in wavelength bands that tend to include disturbances. Even if the peaks p1 to p9 and the peaks p11 to p19 are avoided, disturbances also affect pixel values of other wavelength bands. Therefore, to increase the analysis accuracy of the brazing task, it is desirable to perform the first determination by avoiding the first period in which the disturbance occurs.

As an example, the base material is made of copper; and the brazing material is made of phosphorus copper. The melting point (the solid phase line) of phosphorus copper brazing (BCuP-2) is 710° C. In such a case, the base material is heated to about 700° C. The first wavelength band is set to 544 nm±10 nm. The second wavelength band is set to 780 nm±10 nm.

As another example, the base material is made of steel; and the brazing material is made of silver. The melting point (the solid phase line) of silver brazing (BAg-24) is 660° C. In such a case, the base material is heated to about 600° C. The first wavelength band is set to 460 nm±10 nm. The second wavelength band is set to 600 nm±10 nm.

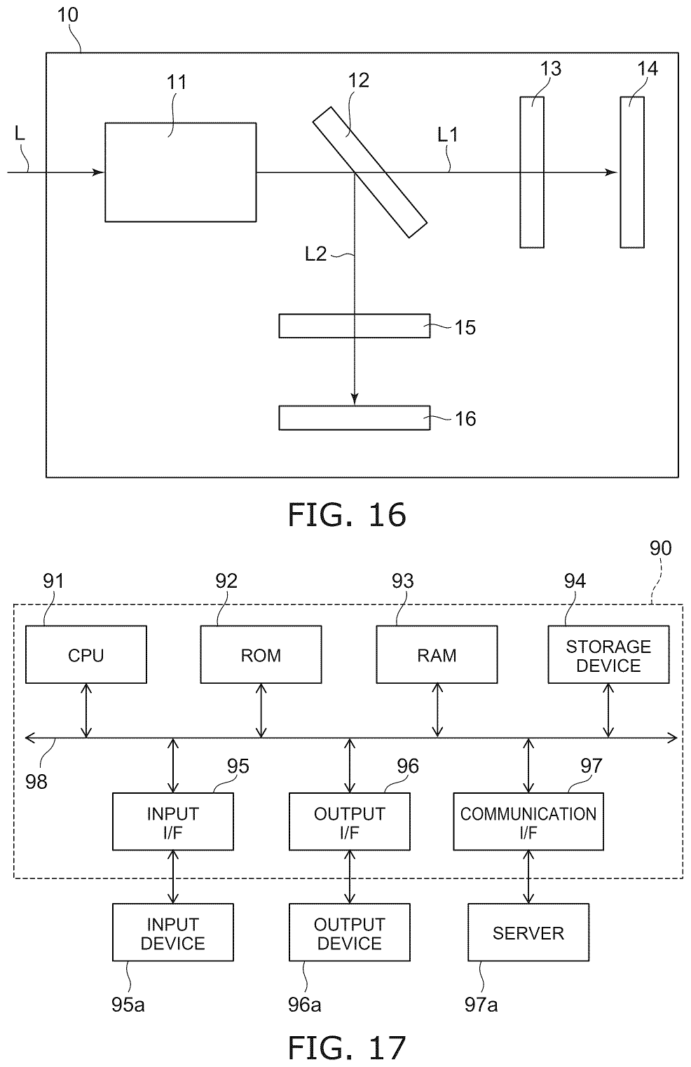

FIG. 16 is a schematic view showing a configuration of an imaging device.

According to the embodiment, it is sufficient to be able to acquire only the light included in the first wavelength band and the light included in the second wavelength band. For example, as shown in FIG. 16, the imaging device 10 includes an optical system 11, a beam splitter 12, a first filter 13, a first image sensor 14, a second filter 15, and a second image sensor 16.

The optical system 11 includes one or more lenses. A light L is incident on the optical system 11. The light that is transmitted by the optical system 11 is incident on the beam splitter 12. The light L is split by the beam splitter 12 into a light L1 and a light L2. The light L1 is incident on the first filter 13. The first filter 13 is a filter that transmits only the light of the first wavelength band. The light L1 that is transmitted by the first filter 13 is incident on the first image sensor 14. The first image sensor 14 generates the first image by converting the light L1 of the first wavelength band into an electrical signal.

The light L2 is incident on the second filter 15. The second filter 15 is a filter that transmits only the light of the second wavelength band. The light L2 that is transmitted by the second filter 15 is incident on the second image sensor 16. The second image sensor 16 generates the second image by converting the light L2 of the second wavelength band into an electrical signal.

For example, the light of the first wavelength band and the light of the second wavelength band also can be acquired by a spectral camera. However, a spectral camera is large compared to a normal camera. When a camera is mounted to the worker, a spectral camera may interfere with the task. By using the imaging device 10 of the configuration shown in FIG. 16, the first image based on the light of the first wavelength band and the second image based on the light of the second wavelength band can be acquired while preventing the imaging device 10 from becoming large. The imaging device 10 shown in FIG. 16 is favorable for a brazing task.

FIG. 17 is a schematic view illustrating a configuration of a computer that performs the analysis method according to the embodiment. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and can cause the output device 96a to display an image.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

Processing related to the analysis may be performed by one computer 90 or may be performed by multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the data of the recording medium is read by a computer (or an embedded system). The recording format (the storage format) of the recording medium is arbitrary. For example, the computer reads a program from the recording medium and causes a CPU to execute instructions based on the program. The computer may acquire (or read) the program via a network.

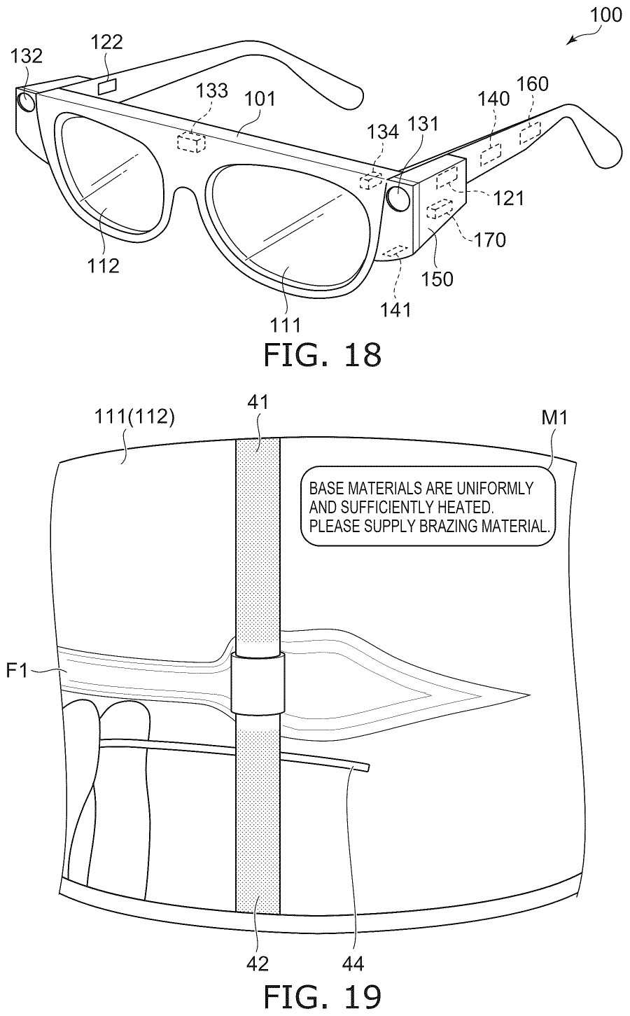

FIG. 18 is a perspective view showing an example of a head mounted display.

The computer that performs the analysis method may be embedded in a head mounted display (HMD). For example, as shown in FIG. 18, the HMD 100 includes a frame 101, a lens 111, a lens 112, a projection device 121, a projection device 122, an image camera 131, a depth camera 132, a light source 133, an eye tracking camera 134, a sensor 140, a microphone 141, a processing device 150, a battery 160, and a storage device 170.

In the illustrated example, the HMD 100 is a binocular head mounted display. Two lenses, i.e., the lens 111 and the lens 112, are fit into the frame 101. The projection device 121 and the projection device 122 respectively project information onto the lenses 111 and 112.

The projection device 121 and the projection device 122 display information of the brazing task, various determination results, etc., on the lenses 111 and 112. Only one of the projection device 121 or the projection device 122 may be included; and information may be displayed on only one of the lens 111 or the lens 112.

The lens 111 and the lens 112 are light-transmissive. The worker can visually recognize reality via the lenses 111 and 112. Also, the worker can visually recognize the information projected onto the lenses 111 and 112 by the projection devices 121 and 122. Information is displayed to overlap real space by being projected by the projection devices 121 and 122.

The image camera 131 detects visible light and obtains a two-dimensional image. The image camera 131 may be a spectral camera, but favorably includes the configuration shown in FIG. 16. The depth camera 132 irradiates infrared light and obtains a depth image based on the reflected infrared light. The light source 133 irradiates light (e.g., infrared light) toward an eyeball of the wearer. The eye tracking camera 134 detects light reflected by the eyeball of the wearer. The sensor 140 is a six-axis detection sensor and is configured to detect angular velocities in three axes and accelerations in three axes. The microphone 141 accepts an audio input.

The processing device 150 controls components of the HMD 100. For example, the processing device 150 controls the projection devices 121 and 122 and causes the projection devices 121 and 122 to display information on the lenses 111 and 112. Hereinbelow, the processing device 150 using the projection devices 121 and 122 to display information on the lenses 111 and 112 also is called simply “the processing device displaying information”. The processing device 150 also detects movement of the visual field based on a detection result of the sensor 140. The processing device 150 modifies the display by the projection devices 121 and 122 according to the movement of the visual field.

The processing device 150 performs steps S2 to S8 of the analysis method shown in FIG. 2 by using the images acquired by the image camera 131. The processing device 150 may display the processing results obtained by the analysis method. The processing device 150 also may recognize the surface shape of the object based on the image obtained by the depth camera 132. The processing device 150 may calculate the viewpoint and line of sight of the eyes of the worker based on the detection result obtained by the eye tracking camera 134.

The battery 160 supplies power necessary for the operations to the components of the HMD 100. The storage device 170 stores data necessary for the processing of the processing device 150, data obtained by the processing of the processing device 150, etc. The storage device 170 may be located outside the HMD 100, and may communicate with the processing device 150.

The display device is not limited to the illustrated example, and may be a monocular head mounted display. The display device may be an eyeglasses-type as illustrated, or may be a helmet-type.

The HMD 100 may include a display instead of the lens 111, the lens 112, the projection device 121, and the projection device 122. In such a case, the display displays a video image that is imaged by the image camera 131. The wearer ascertains the conditions of the surroundings based on the video. Information of the brazing task, various determination results, etc., also are displayed by the display.

FIGS. 19 to 21 are schematic views showing display examples of the head mounted display.

For example, as shown in FIG. 19, the worker W views the first member 41 and the second member 42 via the transmissive lenses 111 and 112. When the brazing task is started, the image camera 131 images the first member 41 and the second member 42. The processing device 150 uses the acquired image to perform steps S2 to S8 of the analysis method AM shown in FIG. 2.

As an example, the first determination determines the first member 41 and the second member 42 to be sufficiently heated; and the second determination determines the first member 41 and the second member 42 to be uniformly heated. In such a case, the processing device 150 displays a message M1 indicating the determination result as shown in FIG. 19. The message M1 may be output as a voice.

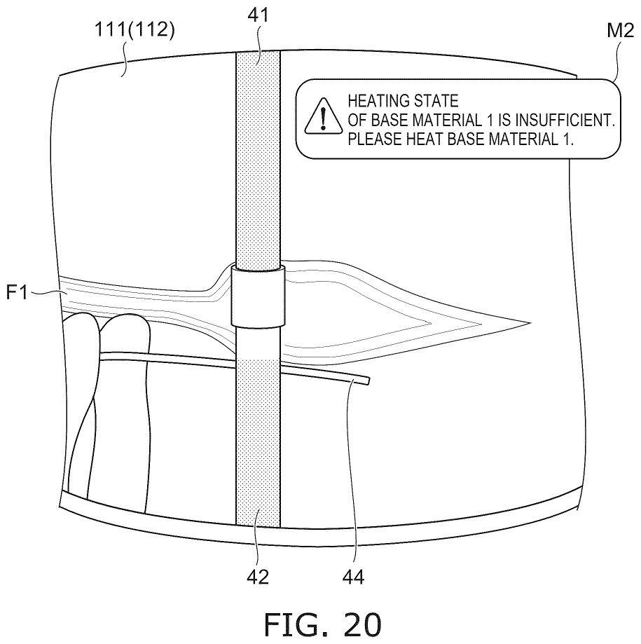

As another example, the first determination determines the heating state of the first member 41 to be insufficient. In such a case, the processing device 150 displays a message M2 indicating the determination result as shown in FIG. 20. The message M2 may include a task instruction prompting the worker to heat the first member 41. The message M2 may be output as a voice.

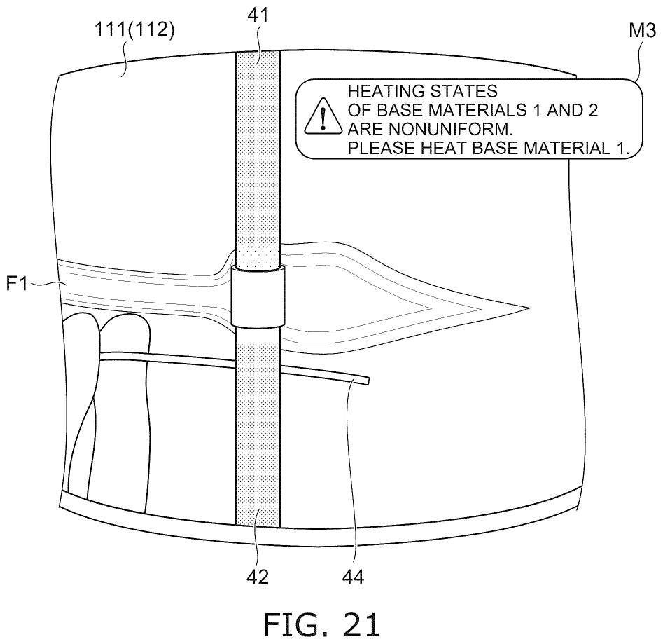

As another example, the first determination determines the heating states of the first and second members 41 and 42 to be sufficient; and the second determination determines the heating states of the first and second members 41 and 42 to be nonuniform. In such a case, the processing device 150 displays a message M3 indicating the determination result as shown in FIG. 21. The message M3 may include a task instruction prompting the worker to more uniformly heat the first member 41 and the second member 42 by heating one of the members. The message M3 may be output as a voice.

In the display example shown in FIG. 21, the location that needs to be heated among the members to be heated may be specifically displayed as in FIG. 9C. For example, when the processing device 150 determines that the heating state of the first member 41 and the heating state of the second member 42 are nonuniform, the determination regions that are set for the members to be heated are displayed. As a result, the worker can specifically ascertain which locations of the members should be heated.

At least a portion of the processing of steps S2 to S8 shown in FIG. 2 for the HMD according to the embodiment may be performed by an external computer. For example, the HMD is connected by wireless communication with a computer prepared separately from the HMD. The HMD transmits, to the external computer, the acquired images or results of processing that uses the images. The computer performs processing by using the received data, and transmits the processing results to the HMD.

As one specific example, when acquiring the first and second images, the HMD transmits the images to the external computer. The computer collects the first and second images and performs steps S3 to S7. The computer transmits, to the HMD, the determination results obtained by steps S3 to S7.

In such a case, the external computer also can be considered to be a part of the HMD 100 according to the embodiment. Because the external computer performs at least a portion of the data processing, the processing device 150 can be smaller and lighter; and the convenience of the HMD 100 is improved.

Embodiments of the invention include the following features.

### Feature 1

An analysis method of analyzing a brazing task of first and second members, the method including:
causing a computer to
   acquire a first image of a first wavelength band in which the brazing task is visible,
   acquire a second image of a second wavelength band in which the brazing task is visible, the second wavelength band having a longer wavelength than the first wavelength band,
   determine a first period based on a plurality of pixel values including a pixel value of the first image and a pixel value of one or more of the first images acquired previously, a disturbance to the analysis occurring in the first period,
   determine whether or not a timing at which the second image is imaged is included in the first period, and
   when the timing is not included in the first period, perform a first determination of using the second image to determine whether or not a heating state of the first member is sufficient and whether or not a heating state of the second member is sufficient.

### Feature 2

The method according to feature 1, in which
when the timing is included in the first period, the computer does not perform the first determination or invalidates a result of the first determination.

### Feature 3

The method according to feature 1 or 2, in which
when the timing is not included in the first period, the computer is caused to further perform a second determination of using the second image to determine a uniformity between the heating state of the first member and the heating state of the second member.

### Feature 4

The method according to any one of features 1 to 3, in which
the first wavelength band is selected from within a range of not less than 420 nm but less than 620 nm, and
the second wavelength band is selected from within a range of not less than 650 nm but less than 950 nm.

### Feature 5

The method according to feature 4, in which
a difference between an upper limit and a lower limit of the first wavelength band is less than 20 nm, and
a difference between an upper limit and a lower limit of the second wavelength band is less than 20 nm.

### Feature 6

The method according to any one of features 1 to 5, in which
the computer is caused to:
   acquire a first waveform, the first waveform being of
      a relationship between time and a pixel value, or
      a relationship between time and a change of the pixel value; and
   determine, as the first period, a period of the first waveform in which
      the pixel value is greater than a threshold, or
      the change of the pixel value is greater than a threshold.

### Feature 7

The method according to any one of features 1 to 5, in which
the computer is caused to:
   extract an edge of the first member and an edge of the second member from the first image or the second image, and
   determine the first period by using an average value of pixel values of a portion of the first member and an average value of pixel values of a portion of the second member in the first image.

### Feature 8

The method according to any one of features 1 to 7, in which
the computer is caused to:
   extract an edge of the first member and an edge of the second member from the first image or the second image; and
   perform the first determination by using an average value of pixel values of a portion of the first member and an average value of pixel values of a portion of the second member in the second image.

### Feature 9

An analysis device, including:
a computer including a processing circuit,
the processing circuit being configured to perform the method according to any one of features 1 to 8.

### Feature 10

An analysis system, including:
the analysis device according to feature 9; and
an imaging device configured to acquire the first and second images.

### Feature 11

The system according to feature 10, in which
the imaging device includes:
   a first filter configured to selectively transmit light included in the first wavelength band;
   a first image sensor configured to receive light transmitted by the first filter;
   a second filter configured to selectively transmit light included in the second wavelength band; and
   a second image sensor configured to receive light transmitted by the second filter.

### Feature 12

A program, when executed by a computer, causing the computer to perform the method according to any one of features 1 to 8.

### Feature 13

A storage medium storing the program according to feature 12.

### Feature 14

A head mounted display, including:
an imaging device configured to repeatedly acquire a first image of a first wavelength band and repeatedly acquire a second image of a second wavelength band by imaging a brazing task of first and second members, the second wavelength band having a longer wavelength than the first wavelength band;
a display device configured to display information to a wearer; and
a processing circuit,
the processing circuit being configured to
   determine a disturbance time period based on pixel values of a plurality of the first images,
   extract a second image among a plurality of the second images that is acquired in a time period other than the disturbance time period,
   perform a first determination of using the extracted second image to determine whether or not a heating state of the first member is sufficient and whether or not a heating state of the second member is sufficient, and
the display device being configured to display an alert
   when the heating state of the first member is insufficient, or
   when the heating state of the second member is insufficient.

### Feature 15

The head mounted display according to feature 14, in which
the display device is configured to:
   when the heating state of the first member is insufficient, display a location at which the heating state of the first member is insufficient; and
   when the heating state of the second member is insufficient, display a location at which the heating state of the second member is insufficient.

### Feature 16

The head mounted display according to feature 14 or 15, in which
the processing circuit is further configured to perform a second determination of using the extracted second image to determine a uniformity between the heating state of the first member and the heating state of the second member.

### Feature 17

The head mounted display according to feature 16, in which
the display device is configured to display a member or a location to be heated when the heating state of the first member and the heating state of the second member are nonuniform.

### Feature 18

The head mounted display according to any one of features 14 to 17, in which
the processing circuit is configured to extract an edge of the first member and an edge of the second member from a plurality of the first images or a plurality of the second images, and
the display device displays the edge of the first member and the edge of the second member.

### Feature 19

The head mounted display according to any one of features 14 to 18, in which
the imaging device includes:
   a first filter configured to selectively transmit light included in the first wavelength band;
   a first image sensor configured to receive light transmitted by the first filter;
   a second filter configured to selectively transmit light included in the second wavelength band; and
   a second image sensor configured to receive light transmitted by the second filter.

In the specification, “or” means that “at least one” of the components listed in the text can be employed.

According to the embodiments above, an analysis method, an analysis device, an analysis system, a program, a storage medium, and a head mounted display are provided in which the analysis accuracy of a brazing task that uses an image can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. An analysis method of analyzing a brazing task of first and second members, the method comprising:
causing a computer to
acquire a first image of a first wavelength band in which the brazing task is visible,
acquire a second image of a second wavelength band in which the brazing task is visible, wavelengths of the second wavelength band being longer than wavelengths of the first wavelength band,
determine a first period based on a plurality of pixel values including a pixel value of the first image and a pixel value of one or more of the first images acquired previously, a disturbance to the analysis occurring in the first period,
determine whether or not a timing at which the second image is imaged is included in the first period, and
when the timing is not included in the first period, perform a first determination of using the second image to determine whether or not a heating state of the first member is sufficient and whether or not a heating state of the second member is sufficient.

2. The method according to claim 1, wherein
when the timing is included in the first period, the computer does not perform the first determination or invalidates a result of the first determination.

3. The method according to claim 1, wherein
when the timing is not included in the first period, the computer is caused to further perform a second determination of using the second image to determine a uniformity between the heating state of the first member and the heating state of the second member.

4. The method according to claim 1, wherein
the first wavelength band is selected from within a range of not less than 420 nm but less than 620 nm, and
the second wavelength band is selected from within a range of not less than 650 nm but less than 950 nm.

5. The method according to claim 4, wherein
a difference between an upper limit and a lower limit of the first wavelength band is less than 20 nm, and
a difference between an upper limit and a lower limit of the second wavelength band is less than 20 nm.

6. The method according to claim 1, wherein
the computer is caused to:
acquire a first waveform, the first waveform being of
a relationship between time and a pixel value, or
a relationship between time and a change of the pixel value; and
determine, as the first period, a period of the first waveform in which
the pixel value is greater than a threshold, or
the change of the pixel value is greater than a threshold.

7. The method according to claim 1, wherein
the computer is caused to:
extract an edge of the first member and an edge of the second member from the first image or the second image, and
determine the first period by using an average value of pixel values of a portion of the first member and an average value of pixel values of a portion of the second member in the first image.

8. The method according to claim 1, wherein
the computer is caused to:
extract an edge of the first member and an edge of the second member from the first image or the second image; and
perform the first determination by using an average value of pixel values of a portion of the first member and an average value of pixel values of a portion of the second member in the second image.

9. An analysis device, comprising:
a computer including a processing circuit,
the processing circuit being configured to perform the method according to claim 1.

10. An analysis system, comprising:
the analysis device according to claim 9; and
an imaging device configured to acquire the first and second images.

11. The system according to claim 10, wherein
the imaging device includes:
a first filter configured to selectively transmit light included in the first wavelength band;
a first image sensor configured to receive light transmitted by the first filter;
a second filter configured to selectively transmit light included in the second wavelength band; and
a second image sensor configured to receive light transmitted by the second filter.

12. A storage medium storing a program,
the program, when executed by a computer, causing the computer to perform the method according to claim 1.

13. A head mounted display, comprising:
an imaging device configured to repeatedly acquire a first image of a first wavelength band and repeatedly acquire a second image of a second wavelength band by imaging a brazing task of first and second members, wavelengths of the second wavelength band being longer than wavelengths of the first wavelength band;
a display device configured to display information to a wearer; and
a processing circuit,
the processing circuit being configured to
determine a disturbance time period based on pixel values of a plurality of the first images,
extract a second image among a plurality of the second images that is acquired in a time period other than the disturbance time period,
perform a first determination of using the extracted second image to determine whether or not a heating state of the first member is sufficient and whether or not a heating state of the second member is sufficient, and
the display device being configured to display an alert
when the heating state of the first member is insufficient, or
when the heating state of the second member is insufficient.

14. The head mounted display according to claim 13, wherein
the display device is configured to:
when the heating state of the first member is insufficient, display a location at which the heating state of the first member is insufficient; and
when the heating state of the second member is insufficient, display a location at which the heating state of the second member is insufficient.

15. The head mounted display according to claim 13, wherein
the processing circuit is further configured to perform a second determination of using the extracted second image to determine a uniformity between the heating state of the first member and the heating state of the second member.

16. The head mounted display according to claim 15, wherein
the display device is configured to display a member or a location to be heated when the heating state of the first member and the heating state of the second member are nonuniform.

17. The head mounted display according to claim 13, wherein
the processing circuit is configured to extract an edge of the first member and an edge of the second member from a plurality of the first images or a plurality of the second images, and
the display device displays the edge of the first member and the edge of the second member.

18. The head mounted display according to claim 13, wherein
the imaging device includes:
a first filter configured to selectively transmit light included in the first wavelength band;
a first image sensor configured to receive light transmitted by the first filter;
a second filter configured to selectively transmit light included in the second wavelength band; and
a second image sensor configured to receive light transmitted by the second filter.
